(19) United States
(12) Patent Application Publication
(10) Pub. No.: US 2003/0127845 A1
(43) Pub. Date: Jul. 10, 2003

(54) Method and apparatus for retaining an article in photo book

(76) Inventor: Lesley J. Mattos, Mountain View, CA (US)

Correspondence Address: MOSER, PATTERSON & SHERIDAN, L.L.P., Suite 1500, 3040 Post Oak Blvd., Houston, TX, 77056, US

(21) Appl. No.: 10/306,489

(22) Filed: Nov. 27, 2002

Related U.S. Application Data
(60) Provisional application No. 60/335,150, filed on Nov. 30, 2001.

(51) Int. Cl. B42D 1/00

(52) U.S. Cl. 281/38

(57) ABSTRACT

The present invention generally relates to a method and apparatus for retaining an article and particularly to a book for retaining photographs. More particularly, the invention relates to a photo guest book where the photographs can be placed in the photo guest book as they are taken and the subject of the photograph can contemporaneously write a description adjacent the photograph as it relates to the photograph or as it relates to the event. The photograph may be a Polaroid® photograph that develops within moments of being taken or a digital photograph that is printed immediately or at a later time. In one embodiment, a book for retaining an article comprises a first cover and a second cover with one or more pages bound together and disposed in between the first and second covers. In addition, a window for a photograph is disposed on one or more of the bound page(s), and a writing space is disposed adjacent the window. A slot is formed on the bound page whereby the photo can be inserted through the slot and into the window. The pages of the photo book are constructed so that the thickness of each of the bound page(s) is such that inserting the photograph into the window will not increase the overall thickness of the page of the book.

### CROSS-REFERENCE TO RELATED APPLICATIONS

This application claims benefit of U.S. provisional patent application Ser. No. 60/335,150 filed Nov. 30, 2001, which is herein incorporated by reference.

### BACKGROUND OF THE INVENTION

1. Field of the Invention

Embodiments of the present invention generally relate to a method and apparatus for retaining an article and particularly to a book for retaining photographs. More particularly, the invention relates to a photo guest book wherein photographs can be placed in the book as they are taken and a written description of the photograph or of the event can be added contemporaneously.

2. Description of the Related Art

Photo albums have been around for a long time. The advent of photographic film changed the way people live and the way they remember personal, social and historic events. For well over a century, people have been taking photos of everyday life, including birthdays, social events, graduations, weddings and holidays, and placing them in some sort of book for safekeeping and future viewing. The photo books have evolved into very elegant hand crafted books not only used for the everyday photos but also for very specific events.

Some of the problems encountered with today's photo albums include remembering details about the occasions, people and places that are the subject of the photos. For example, there are many instances when numerous photos are taken at a party and after developing the photos, the owner of the photographs may not remember the identity of the people or places or remember the significance of an activity captured in the photo. An age-old solution to the problem included notation on the back of a developed photo, but these are not made contemporaneously with the event and are therefore often inaccurate. Another problem associated with the prior art photo books is that once the book is filled with photos, the overall size of the book is increased in thickness due to a stacking effect of the relatively thick photograph paper. In addition, the increased size tends to breakdown the book over time.

Therefore, there exists a need for a method and apparatus that can retain a photo in a photo book while permitting a written note to be contemporaneously added to the book near the photo. There is a further need for a method and apparatus for retaining a photo in a book so that the overall thickness of the photo book does not increase as the photo book is filled with photos.

### SUMMARY OF THE INVENTION

The present invention generally relates to a method and apparatus for retaining an article and particularly to a book for retaining photographs. More particularly, the invention relates to a photo guest book where the photographs can be placed in the photo guest book during the course of the event and the subject of the photograph can contemporaneously write a description adjacent the photograph as it relates to the photograph or as it relates to the event. The photograph may be a Polaroid® photograph that develops within moments of being taken or a digital photograph that is printed immediately or at a later time. In one embodiment, a book for retaining an article comprises a first cover and a second cover with one or more pages bound together and disposed in between the first and second covers. In addition, a window for a photograph is disposed on one or more of the bound page(s), and a writing space is disposed adjacent the window. A slot is formed on the bound page whereby the photo can be inserted through the slot and into the window. The pages of the photo book are constructed so that the thickness of each of the bound page(s) is such that inserting the photograph into the window will not increase the overall thickness of the page or the book.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view of the photo guest book of the present invention showing the guest book in an open position with a window for a photo and a writing space above or below the window.

FIG. 2 is a view of FIG. 1 with a photo placed in the window of both pages.

FIG. 3 is a view of the photo book of FIG. 2 with a note written in the writing space adjacent each photo.

### DETAILED DESCRIPTION OF THE PREFERRED EMBODIMENT

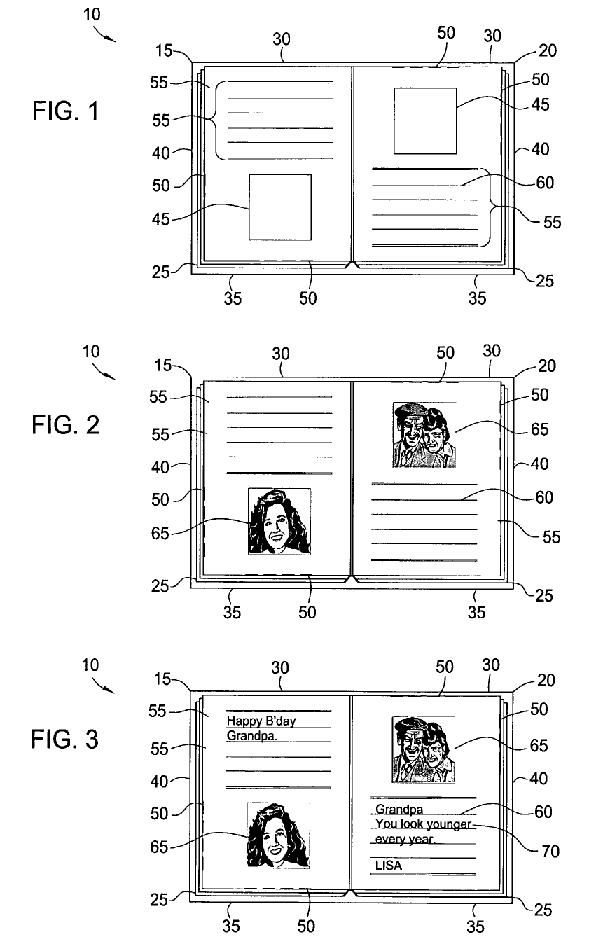

The present invention includes a method and apparatus for retaining and displaying a photograph in a photo album with a writing space provided adjacent the photo. The writing space is included on each page along with a photo window so that a photo can be taken and placed in the photo guest book and a note or inscription can be contemporaneously written in the space adjacent the photo. The writing space can also be on a completely separate page (not shown) from the photo. Contemporaneously, as used herein, means originating, existing or happening during a relatively short time before or after an event. FIG. 1 is a front view of a photo guest book 10 in an open position with a first cover 15 and a second cover 20. Disposed between the covers 15, 20 are one or more page(s) 25. The pages 25 are held between the covers 15, 20 in a manner using adhesives or spiral binding well known to those in the book binding business. Also shown in FIG. 1, a window 45 is provided so a photo 65 (as shown in FIG. 2) may be inserted into window 45 after it has been taken. The photo 65 (as shown in FIG. 2) may be inserted into window 45 through a slot 50 (shown as dotted lines) disposed on one or more of the bound page(s) 25 either above window 45, below window 45 or to the side of window 45 depending how window 45 is positioned on bound page(s) 25. FIGS. 1, 2 and 3 also show a writing space 55 comprising either an open space (not shown) or one or more pre-printed lines 60 for writing an inscription or note about the photo, event, etc. The writing space 55 is positioned either directly above window 45, directly below window 45, or to the side of window 45 depending on how window 45 is positioned on the one or more bound pages 25. The writing space can also be on a completely separate page (not shown) from the photo. The bound page(s) 25 are constructed so that each page is of a double thickness such that inserting a photograph 65 (shown in FIG. 2) into window 45 will not increase the overall thickness of each page 25 of the entire guest book 10.

In operation, as shown in FIGS. 1, 2 and 3, photo guest book 10 is opened so that first cover 15 and second cover 25 are laying flat, leaving bound page(s) 25, window 45 and writing space 55 displayed. A photo 65 is taken, for example, of some friends invited to a birthday party. As a recently taken photo is developing or after it is printed the photo 65 can be inserted through slot 50 into window 45 until the photo is positioned completely inside window 45 and is completely visible from the outside. Once photo 65 is positioned in window 45, an inscription or note 70 can be written in writing space 55 on one or more of the preprinted lines 60. All of the above steps can be performed contemporaneously. The method can then repeated until all of the windows 45 and writing spaces 55 disposed on bound page(s) 25 are filled with photos 65 and inscriptions or notes 70 respectively. As one skilled in the art, it is apparent that the method in which the photo guest book 10 is completed can be done in a variety of ways. For example, photo 65 could be taken, inscription or note 70 could be written into writing space 55 and photo 65 could then be inserted through slot 50 into window 45. Another variation may proceed by writing an inscription or note 70 into writing space 55, taking a photo 65, and then inserting this photo 65 through slot 30 and into window 45.

In another embodiment, the photo book may have a window on one or more of the pages and a writing space on a completely separate page. In addition, the writing space may not comprise any pre-printed lines.

While the foregoing is directed to embodiments of the present invention, other and further embodiments of the invention may be devised without departing from the basic scope thereof, and the scope thereof is determined by the claims that follow.

1. A book for retaining an article comprising:
a first cover;
a second cover;
one or more pages bound together and disposed between the first and second covers;
at least one window formed in the at least one page, the window constructed and arranged to hold the article in a manner that exposes the article for viewing;
a writing space disposed adjacent the at least one window; wherein the thickness of each page is such that inserting the photo into the window will not increase the thickness of the pages or the book.

2. The book of claim 1, wherein the article is a photo.

3. The book of claim 2, wherein the window includes a slot to facilitate the insertion of the photo.

4. The book of claim 3, wherein the slot is formed along one side of the window.

5. The book of claim 3, wherein the window is positioned on a top half of at least one page.

6. The book of claim 3, wherein the window is positioned on the bottom half of the at least one page.

7. The book of claim 1, wherein the writing space comprises one or more preprinted lines.

8. The book of claim 7, wherein the writing space is positioned within one half of the page adjacent the window.

9. A method of retaining a photo comprising:
taking the photo;
inserting the photo into a window formed on a page of a book;
writing in a space provided on the page adjacent the window.

10. The method of claim 9, wherein the insertion and writing are performed contemporaneously with the taking of the photo.
